(19) United States
(12) Patent Application Publication
(10) Pub. No.: US 2012/0069065 A1
(43) Pub. Date: Mar. 22, 2012

(54) ELECTRONIC PAPER DISPLAY DEVICE

(75) Inventors: Hwan-Soo Lee, Seoul (KR); Hye Yeon Cha, Yongin (KR); Jung Min Park, Suwon (KR); Yongsoo Oh, Seongnam (KR)

(73) Assignee: SAMSUNG ELECTRO-MECHANICS CO., LTD.

(21) Appl. No.: 13/229,055

(22) Filed: Sep. 9, 2011

(30) Foreign Application Priority Data
Sep. 17, 2010 (KR) 10-2010-0091710

(51) Int. Cl. G09G 5/10

(52) U.S. Cl. 345/691; 345/690

(57) ABSTRACT

There is provided an electronic paper display device. The electronic paper display device includes a substrate including a plurality of cells formed by a plurality of barrier ribs; an upper electrode and a lower electrode respectively formed on an upper surface and a lower surface of the substrate; and an electronic paper display element mounted in each of the cells and having optical and electrical anisotropy. Here, torque applied to the electronic paper display element is controlled to express grayscale.

### CROSS-REFERENCE TO RELATED APPLICATIONS

This application claims the priority of Korean Patent Application No. 10-2010-0091710 filed on Sep. 17, 2010, in the Korean Intellectual Property Office, the disclosure of which is incorporated herein by reference.

### BACKGROUND OF THE INVENTION

1. Field of the Invention

The present invention relates to an electronic paper display device, and more particularly to an electronic paper display device capable of expressing grayscale by controlling torque applied to a display element mounted therein.

2. Description of the Related Art

At present, a change in the way in which information is transferred and shared is needed, corresponding to the requirement for a new paradigm in the modern information society. In order to satisfy such a requirement, the technological development of electronic paper, which has advantages such as flexibility, as a flexible display has been accelerated, and the technological development of electronic paper is nearing the stage of commercialization.

Electronic paper, as compared to existing flat panel displays, is lower in terms of the unit cost of production. In addition, since electronic paper does not require background lighting or continuous recharging, it can be driven even with low-level energy, and therefore, is be far superior to the existing flat panel displays in terms of energy efficiency. Further, the electronic paper has realized a very clear image and a wide viewing angle, and has a memory function by which the display of characters may be retained even when power is not applied thereto.

Due to these advantages, electronic paper may have a wide range of applications, such as in an electronic book having a paper-like appearance and including moving illustrations, a renewable newspaper, a reusable paper display for mobile phone, a disposable TV screen, electronic wallpaper, or the like, and has huge market potential.

Technological approaches to the implementation of electronic paper may be classified into four methods: a twist ball method in which spherical particles formed of upper and lower hemispheres having different colors and electric charges opposed to each other are rotated by using an electric field; an electrophoresis method in which charged colored particles mixed with oil are confined in micro capsules or micro-cups and the charged particles are made to respond to the application of an electric field, a quick response-liquid powder display (QR-LPD) method using charged liquid powder, and a cholesteric liquid crystal display (Ch-LCD) method using selective reflection characteristic of cholesteric liquid crystal molecules.

Among them, the electronic paper according to the twist ball method has a configuration in which a plurality of twist balls each having a black-colored hemisphere, are disposed between two parallel transmissive sheets (hereinafter, referred to as an elastomer matrix) made of a material such as an elastomer.

The twist balls have optical and electrical anisotropy. In other words, a white hemisphere and a black hemisphere are respectively charged with charges of different levels or of different polarities, and this may lead to permanent dipolarization. In addition, the twist ball is coated with liquid so as to be rotatable in an elastomer matrix.

In other words, the electronic paper using the twist balls is capable of displaying a desired image by having an electric field applied to the elastomer matrix to selectively rotate the twist balls.

These twist balls have difficulties in performing black/white conversion as well as expressing grayscale, in comparison with the related art methods such as electrophoresis, or the like.

### SUMMARY OF THE INVENTION

An aspect of the present invention provides an electronic paper display device capable of performing black/white conversion as well as expressing grayscale.

According to an aspect of the present invention, there is provided an electronic paper display device, including: a substrate including a plurality of cells formed by a plurality of barrier ribs; an upper electrode and a lower electrode respectively formed on an upper surface and a lower surface of the substrate; and an electronic paper display element mounted in each of the cells and having optical and electrical anisotropy, wherein torque applied to the electronic paper display element is controlled to express grayscale.

The torque applied to the electronic paper display element may be controlled by regulating a level of voltage applied to the upper electrode and the lower electrode.

The level of voltage may be regulated by a pulse modulation method.

The pulse modulation method may employ pulse width modulation (PWM).

The torque applied to the electronic paper display element may be controlled by regulating time during which voltage is applied.

The torque applied to the electronic paper display element may be controlled by regulating the type and amount of charges of the electronic paper display element.

The torque applied to the electronic paper display element may be controlled by regulating one or more factors selected from the group consisting of a mass of the electronic paper display element, a size of the electronic paper display element, a size of the cell and a roughness of the cell.

The lower electrode may have a thin film transistor (TFT) formed therein.

The cell may be a micro-cup, and the electronic paper display element may be a twist ball.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view schematically showing an electronic paper display device according to an exemplary embodiment of the present invention;

FIG. 2 is a graph showing a rotational voltage of an electronic paper display element according to an exemplary embodiment of the present invention;

FIGS. 3A through 3C are cross-sectional views showing the rotation of electronic paper display elements according to rotational voltages in an electronic paper display device according to an exemplary embodiment of the present invention; and

FIG. 4 is a graph showing rotational voltages of electronic paper display elements according to an exemplary embodiment of the present invention shown in FIGS. 3A through 3C.

### DETAILED DESCRIPTION OF THE PREFERRED EMBODIMENT

Hereafter, exemplary embodiments of the present invention will be described in detail with reference to the accompanying drawings. The exemplary embodiments of the present invention may be modified in many different forms and the scope of the invention should not be construed as being limited to the embodiments set forth herein.

Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

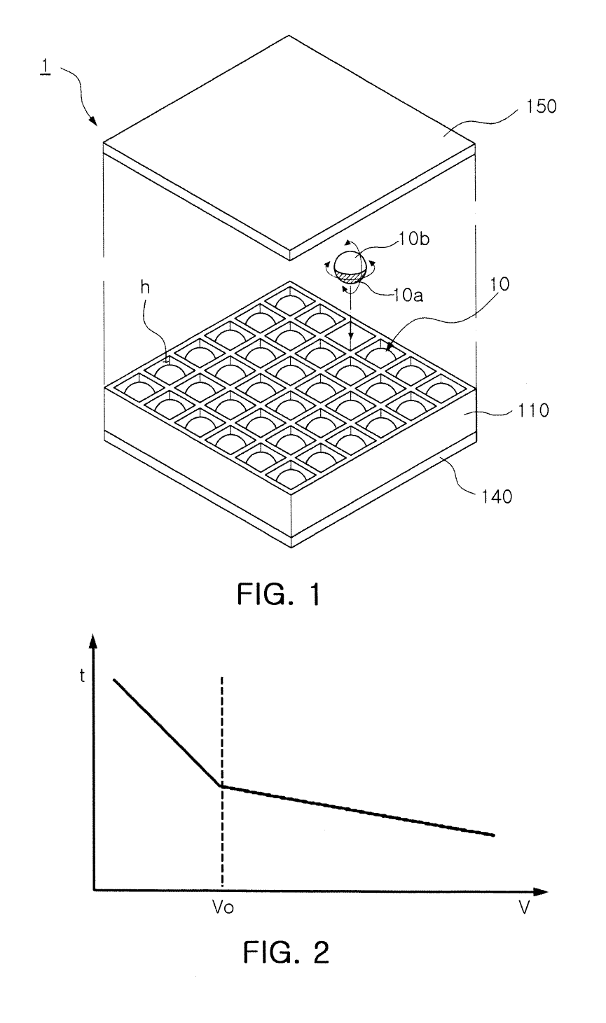

Hereafter, an electronic paper display device according to an exemplary embodiment of the present invention will be described with reference to FIGS. 1 through 4.

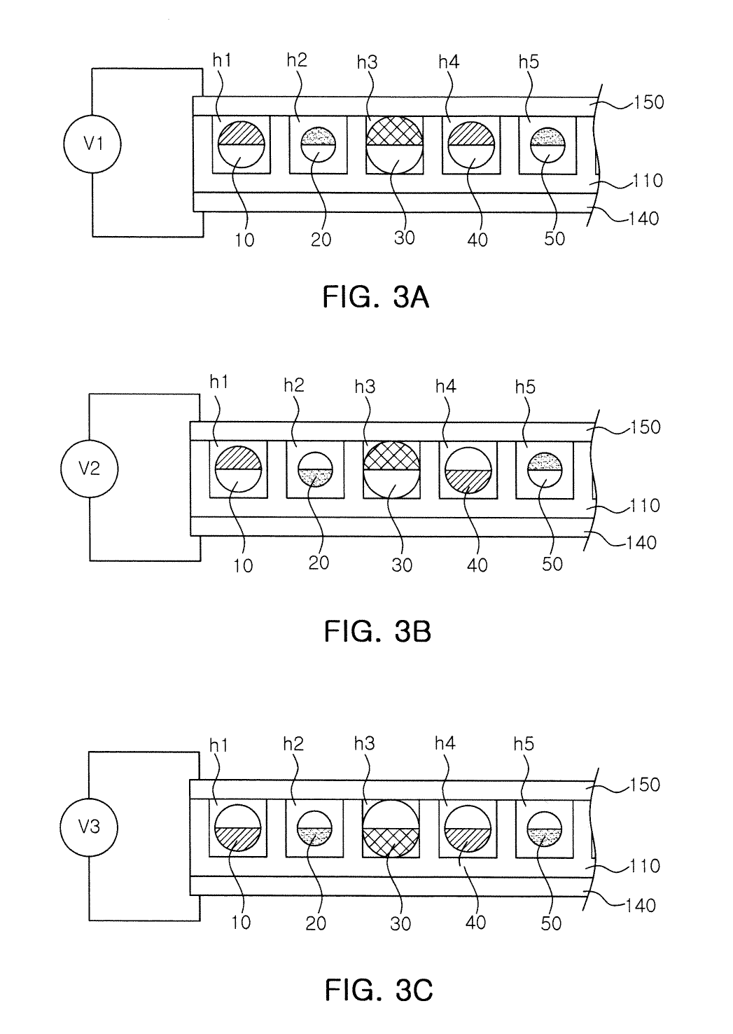

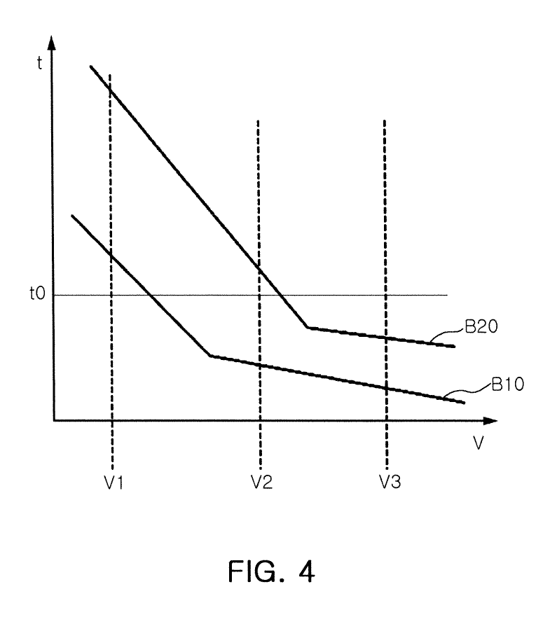

FIG. 1 is an exploded perspective view schematically showing an electronic paper display device according to an exemplary embodiment of the present invention; FIG. 2 is a graph showing a rotational voltage of an electronic paper display element according to an exemplary embodiment of the present invention; FIGS. 3A through 3C are cross-sectional views showing the rotation of electronic paper display elements according to rotational voltages in an electronic paper display device according to an exemplary embodiment of the present invention; and FIG. 4 is a graph showing rotational voltages of electronic paper display elements (hereafter, referred to as “rotatable balls”) according to an exemplary embodiment of the present invention shown in FIGS. 3A through 3C.

Referring to FIG. 1, an electronic paper display device 1 according to an exemplary embodiment of the present invention may include a substrate 110 including a plurality of cell spaces h formed by a plurality of barrier ribs, and an upper electrode 150 and a lower electrode 140 formed on an upper surface and a lower surface of the substrate 110. The cells h are formed to have optical and electric anisotropy, and rotatable balls 10 having different rotational voltages are mounted therein.

For the upper electrode 150 and the lower electrode 140, electrode materials commonly used in the art of the present invention may be used. For example, a conductive polymer such as polythiophene or polyaniline, a metal particle such as silver or nickel, a polymer film including the metal particle, indium-tin-oxide (ITO), or the like may be used.

The lower electrode 140 may be constituted of electric field applying parts or matrix address electrodes, which enable the rotatable balls 10 to be independently drivable. Driving elements, thin film transistors (TFTs) for example, for enabling the rotatable balls 10 disposed in the respective cells h to be independently drivable may be formed in the lower electrode 140.

According to an exemplary embodiment of the present invention, one thin film transistor may be formed in the lower electrode. Different thin film transistors may be formed in the respective cells and independently driven to express grayscale, but according to an exemplary embodiment of the present invention, electronic paper display elements having different rotational voltages are provided and voltage levels are regulated by using one thin film transistor, and thus, grayscale can be expressed in an electronic paper display element.

The substrate 110 may be made of flexible resin, which may include, but is not limited to, for example, polyethyleneterephthalate (PET), polycarbonate (PC), polymethylmethacrylate (PMMA), polyethylenenaphthalates (PEN), polyethersulfone (PES), cyclic olefin polymer (COC), polydimethylsiloxane (PDMS) polyurethane acrylate (PUA), or the like, and a combination of one or more thereof.

The substrate 110 is disposed between the upper electrode 150 and the lower electrode 140, and includes a plurality of barrier ribs partitioning a space between the upper electrode 150 and the lower electrode 140 and cell spaces h formed by the barrier ribs. The cell may be, but is not necessarily limited to, a micro-cup.

According to an exemplary embodiment of the present invention, the cell spaces h accommodate rotatable balls respectively. According to an exemplary embodiment of the present invention, the rotatable ball may be a twist ball. In addition, the cell spaces h may be filled with a dielectric liquid to enable the rotatable balls to be easily rotatable. A plurality of adjacent cell spaces h, which accommodate the plurality of rotatable balls expressing different colors, constitute a pixel area.

The rotatable ball 10 according to an exemplary embodiment of the present invention is colored with different colors, and includes two display regions 10a and 10b exhibiting different charging characteristics.

According to an exemplary embodiment of the present invention, a first display region 10a of the two display regions is colored with either of white or black, and a second display region 10b is colored with any one of a combination of red (R), green (G), and blue (B) and a combination of cyan (C), yellow (Y), and magenta (M). However, the exemplary embodiment of the present invention is not limited thereto. When the first display region 10a is positively charged, the second display region 10b is negatively charged.

Accordingly, the rotatable ball 10 has a permanent dipole through charges with which the first display region 10a and the second display region 10b are charged.

As a result, when an electric field is applied to the rotatable ball 10 by the upper electrode 150 and the lower electrode 140, torque is generated at the dipole according to the strength and direction of the electric field, and thus the rotatable ball is rotated.

τ=r×F

The torque applied to the rotatable ball is affected by the electric field formed by the upper electrode and the lower electrode.

$$τ = r \times qE$$

$$τ = qr \times E = \frac{d L}{d t}$$

The rotatable ball is subjected to electric force within the electric field, and here, the electric force is proportional to the dipole moment of the dipole, and the strength and direction of the electric field. This electric force is applied to the rotatable ball as torque, thereby enabling the rotatable ball to be rotated according to the direction of the electric field. Therefore, both the first display region 10a and the second display region 10b exhibit colors according to the colors of the first display region 10a and the second display region 10b.

$$τ = \frac{d L}{d t} ∝ {\sum }_{i = 1}^{N} {q}_{i} {r}_{i}$$

$$p = {\sum }_{i = 1}^{N} {q}_{i} {r}_{i}$$

More specially, considering the effects of charges with which the rotatable balls are charged, since the electric field applied to the entirety of the rotatable balls is constant, the torque applied to the entirety of the rotatable balls corresponds to the sum of torque applied by charges with which the rotatable balls are charged. That is, the torque applied to the entirety of the rotatable balls is proportional to the dipole moment (p) generated in the rotatable ball.

In other words, the rotation of the rotatable ball is affected by the electric field generated by a voltage difference between the upper electrode and the lower electrode and the dipole moment inside the rotatable ball. That is, the rotation of the rotatable ball is affected by the type of charges and the amount of charges, with which the first display region 10a and the second display region 10b of the rotatable ball are charged.

Meanwhile, an actual force affecting the torque applied to the rotatable ball is determined by the resultant force of electric force and frictional force applied to the rotatable ball.

τ=r×F,F=qE−F_{—}

F_{—}=μN+α

The actual force applied to the rotatable ball is affected by the electric force generated by the electric field and the frictional force (F_) applied to the rotatable ball.

The electric force is offset by the frictional force applied to the rotatable ball. The frictional force may be generated by a frictional coefficient (μ), normal force (N) applied on a surface of a cell by the rotatable ball, and other factors.

The frictional coefficient (μ) is determined by the surface roughness of the rotatable ball and the roughness of the cell in which the rotatable ball is contained, and the normal force (N) is determined by the mass of the rotatable ball. In addition, when the density of the rotatable ball is constant, the normal force (N) may be determined by the radius of the rotatable ball, that is, the size of the rotatable ball.

In other words, the force applied to the rotatable ball may be determined by the roughness of the cell, the mass of the rotatable ball, and the size of the rotatable ball, and thus, the rotation of the rotatable ball can be controlled.

FIG. 2 is a voltage-time graph showing the time during which a rotatable ball is moved when a predetermined voltage is applied thereto.

Referring to FIG. 2, it shows that the rotatable ball is rotated when a rotational voltage is applied to the rotatable ball during the rotation driving time. When a voltage is applied to the rotatable ball during a predetermined time, that is, the rotation driving time, the rotatable ball is rotated. Here, the rotation driving time during which a voltage is applied to the rotatable ball is decreased as the level of voltage is increased.

In other words, when a voltage having a level of the rotational voltage or higher is applied to the rotational ball during the rotation driving time or longer, the rotatable ball is rotated.

Meanwhile, it shows that, in the rotational voltage of the rotatable ball, when a voltage having a level equal to the rotation inflection voltage (Vo) or higher is applied, the rotation driving time during which voltage is applied is almost constant even though the level of voltage is increased.

Therefore, when the voltage having a level equal to the rotation inflection voltage (Vo) or higher of the rotational ball is applied during about the rotation driving time at the rotation inflection voltage, the rotatable ball is rotated at all times.

In other words, when rotatable balls having different rotation inflection voltages (Vo) are mounted in cells and a voltage is applied thereto, only the rotatable balls having lower rotation inflection voltages (Vo) in comparison with the applied voltage are rotated.

According to an exemplary embodiment of the present invention, in display elements having the same rotation inflection voltage (Vo), the rotation of the display elements can be controlled by regulating the voltage applied thereto. In addition, display elements may be rotated or not, even at the same voltage, by regulating the mass and size of the display elements, the type and amount of charges applied thereto, size of the cell or the roughness of the cells, or regulating the rotation inflection voltage (Vo) of the display elements.

Therefore, when the display elements having different rotation inflection voltages (Vo) are mounted in the electronic paper display device and the applied voltage is regulated, the torque applied to each of the display elements can be controlled, and thus, the electronic paper display device is capable of displaying a desired grayscale.

Therefore, when the display elements having different rotation inflection voltages (Vo) are mounted in the electronic paper display device and the time during which voltage is applied is regulated, the torque applied to each of the display elements can be controlled, and thus, the electronic paper display device is capable of displaying a desired grayscale.

In addition, besides regulating the level of voltage of the rotatable ball, the voltage of the rotatable ball may be controlled through a pulse modulation method. In this case, the pulse of electric power may be modulated to obtain the same effect as a case in which the voltage of the rotatable ball is regulated.

The pulse modulation method may employ, but is not limited to, a pulse width modulation (PWM) method. The rotation of the rotatable ball can be controlled according to the level of the voltage at which a desired pulse width is to be obtained.

FIGS. 3A through 3C are cross-sectional views showing an electronic paper display device according to an exemplary embodiment of the present invention, and FIG. 4 is a graph showing rotational voltages of the electronic paper display elements 10 and 20 shown in FIGS. 3A though 3C.

An electronic paper display device according to an embodiment of the present invention includes an upper electrode 150 and a lower electrode 140, a substrate 110 formed between the upper electrode 150 and the lower electrode 140, and a plurality of cells formed inside the substrate.

Rotatable balls 10, 20, 30, 40, and 50, having various values of size, mass, and dipole moment are disposed within the cells.

In other words, the rotatable balls may have various sizes, and even in the case that the rotatable balls may have equal sizes, they may have different mass values, while even in the case that the rotatable balls are equal in terms of size and mass, they may be different from each other in terms of dipole moment, that is, the type and amount of charges with which the first display region 10a and the second display region 10b are charged.

Also, in the case that the rotatable balls have equal size, mass, and dipole moment, different frictional forces may be applied to the rotatable balls by differentiating the roughness of the cells.

Referring to FIGS. 3A and 4, according to this exemplary embodiment of the present invention, it may be shown that, when a voltage V1 having a level equal to or lower than the rotation inflection voltages of the rotatable balls 10 and 20 is applied to the upper electrode 150 and the lower electrode 140 during a time period of t0, the rotatable balls 10 and 20 are not rotated.

In this case, the rotatable balls 10 and 20 are not rotated, and may display black.

Referring to FIG. 3B, when a voltage having a level higher than the rotation inflection voltage of the rotational ball 10 and lower than the rotation inflection voltage of the rotational ball 20 is applied during the time t0, the rotatable ball 10 is rotated to exhibit white, while the rotatable ball 20 is not rotated to exhibit black.

For this reason, gray other than black and white may be exhibited, and especially, the voltage may be regulated to control the contrast of gray. In other words, various gray colors may be exhibited. Therefore, the grayscale of the electronic paper display element can be expressed by using voltage characteristics of the electronic paper display element.

According to an exemplary embodiment of the present invention, black and white are taken as examples of the color exhibited by the electronic paper display element. However, the present invention is not limited thereto. Various colors may be exhibited, and the contrast thereof may be controlled.

According to an exemplary embodiment of the present invention, even without forming thin film transistors (TFTs) in respective cells of the lower electrode of the electronic paper display device, the grayscale of the electronic paper display device can be expressed by forming only one thin film transistor (TFT) and regulating the level of voltage.

Meanwhile, referring to FIG. 3B, two rotatable balls 10 and 20 having different sizes are selected, and have different rotation inflection voltages. As a result, the two rotatable balls 10 and 20 are rotated differently from each other.

Also, when other two rotatable balls 20 and 50 are compared with each other, even though the two rotatable balls 20 and 50 are equal in size, they are made to be different in terms of the mass of the rotatable balls, the roughness of cells, or the type and amount of charges applied to the rotatable balls, thereby having different rotation inflection voltages.

For this reason, even though the two rotatable balls 20 and 50 are equal in size, the rotatable ball 20 may be rotated, while the rotatable ball 50 may not be rotated.

Referring to FIG. 3C, a voltage having a level higher than the rotation inflection voltages of the two rotatable balls 10 and 20 is applied to the two rotatable balls 10 and 20, thereby allowing the rotatable balls 10 and 20 to be rotated. In this manner, all the rotatable balls are rotated, and thus, the electronic paper display device can exhibit white.

According to an exemplary embodiment of the present invention, the level of voltage may be regulated such that a voltage having a level equal to the rotation inflection voltage or higher is applied, as well as the time for voltage application may be controlled, and thus, the rotation of the rotatable ball can be controlled.

In addition, a pulse modulation method may be used for regulating the level of the voltage, and especially, pulse width modulation may be used to regulate the level of the voltage, thereby rotating desired rotatable balls.

According to an exemplary embodiment of the present invention, the rotatable balls having various rotation inflection voltages may be scattered in the electronic paper display device at various desired positions. For this reason, when a predetermined voltage is applied, only the rotatable balls having a rotation inflection voltage lower than the predetermined voltage can be rotated. In other words, the voltage can be regulated to express a desired degree of grayscale.

According to an exemplary embodiment of the present invention, in particular, twist balls may be applied in an electronic paper display device, as a monolayer, and thereby, to express grayscale. Since the twist balls can be expressed in a monolayer, the response speed thereof is fast and the driving voltage required therefor is low.

For this reason, the present invention is applied to an electronic paper display device using the twist balls, and thus, a desired degree of grayscale can be expressed at a fast response speed, and the grayscale of the electronic paper display device can be expressed by using a low driving voltage.

As set forth above, according to exemplary embodiments of the present invention, a twist ball type electronic paper display device capable of performing black/white conversion as well as expressing grayscale can be provided.

While the present invention has been shown and described in connection with the exemplary embodiments, it will be apparent to those skilled in the art that modifications and variations can be made without departing from the spirit and scope of the invention as defined by the appended claims.

What is claimed is:

1. An electronic paper display device, comprising:
a substrate including a plurality of cells formed by a plurality of barrier ribs;
an upper electrode and a lower electrode respectively formed on an upper surface and a lower surface of the substrate; and
an electronic paper display element mounted in each of the cells and having optical and electrical anisotropy,
wherein torque applied to the electronic paper display element is controlled to express grayscale.

2. The electronic paper display device of claim 1, wherein the torque applied to the electronic paper display element is controlled by regulating a level of voltage applied to the upper electrode and the lower electrode.

3. The electronic paper display device of claim 2, wherein the level of voltage is regulated by a pulse modulation method.

4. The electronic paper display device of claim 3, wherein the pulse modulation method employs pulse width modulation (PWM).

5. The electronic paper display device of claim 2, wherein the torque applied to the electronic paper display element is controlled by regulating time during which voltage is applied.

6. The electronic paper display device of claim 1, wherein the torque applied to the electronic paper display element is controlled by regulating the type and amount of charges of the electronic paper display element.

7. The electronic paper display device of claim 1, wherein the torque applied to the electronic paper display element is controlled by regulating one or more factors selected from the group consisting of a mass of the electronic paper display element, a size of the electronic paper display element, a size of the cell and a roughness of the cell.

8. The electronic paper display device of claim 1, wherein the lower electrode has a thin film transistor (TFT) formed therein.

9. The electronic paper display device of claim 1, wherein the cell is a micro-cup.

10. The electronic paper display device of claim 1, wherein the electronic paper display element is a twist ball.
